(19) United States
(12) Patent Application Publication
(10) Pub. No.: US 2025/0221351 A1
(43) Pub. Date: Jul. 10, 2025

(54) MULTI-STORY HORIZONTAL TRELLISING SYSTEMS

(71) Applicant: R.P. GROW-TEC INNOVATIONS LTD., Gazit (IL)

(72) Inventors: Shlomy RAZIEL, Gazit (IL); Ori MINES, Gazit (IL); Nir GALANT, Gazit (IL); Omer PINCHUK, Tel-Aviv (IL); Ron AMAR, Shimshit (IL); Ilan HACOHEN, Gadot (IL); Yuval FRADKIN, Nahalal (IL); Raz BAR-SADE, Gazit (IL)

(21) Appl. No.: 19/108,724

(22) PCT Filed: Sep. 5, 2023
(86) PCT No.: PCT/IL2023/050952

§ 371 Date: Mar. 4, 2025

(30) Foreign Application Priority Data
Sep. 5, 2022 (IL) 296216
Jan. 16, 2023 (IL) 299944

(51) Int. Cl. A01G 31/06; A01G 17/06; A01G 24/18; A01G 31/02

(52) U.S. Cl. CPC A01G 31/06; A01G 17/06; A01G 24/18; A01G 31/024; A01G 2017/065

(57) ABSTRACT

Vertical trellising agriculture is used in indoor and outdoor applications. Drawbacks of vertical trellising are known in the art, and usually concerns aspects related difficulties in compactization of the modules and cascading the production, especially in indoor controlled environments, where typical yields are up to about 350 Kg/m² floor. The present invention discloses multi-story horizontal trellising systems and modules thereof; and provides a modular vertically stackable trellising means with greater yields per square meter floor.

### FILED OF THE INVENTION

The present invention pertains to multi-story horizontal trellising systems, modules and agrotechniques thereof. The invention also relates to modules, indoor and outdoor systems and methods for three-dimensions horizontal-trellising agrotechnology.

### BACKGROUND OF THE INVENTION

Vertical trellising agriculture utilizes for both indoor and outdoor applications. Drawbacks of vertical trellising are known in the art, and usually concerns aspects related difficulties in compactization of the modules and cascading the production, especially in indoor controlled environments, where typical yields are up to about 350 Kg/m² floor. It hence a long felt need to disclose modular vertically stackable trellising system provided by greater yields per square meter floor.

### SUMMARY OF THE INVENTION

It is hence one object of the invention to disclose a multi-story horizontal trellising system (MSHTS) characterized by one or more vertically erected stories; each story comprises an array of growing boxes located at a first end of an array of horizontal trellising wires. For some verities, such an MSHTS yields about 700 Kg/m² floor.

It is another object of the invention to disclose the MSHTS as defined above, wherein it further comprises a member of a group consisting of light emitter, light detector, light-activation processor, CO₂ detector, growing gutter, blower, air conditioning, ventilating ducts, NTP decontaminating system, water irrigator, trellising wires tensioning mechanism, stem/leaves tensioning mechanism, additive applicator, and any combination thereof.

It is another object of the invention to disclose the MSHTS as defined in any of the above, wherein it characterized by that the growing box comprises a member of a group consisting of rockwool/substrate cube; a plastic cover; apertures, L-shaped supporting member backing an about 90°-bend in stem.

It is another object of the invention to disclose a MSHTS characterized by one or more vertically erected stories; each story comprises an array of growing boxes located at a first end of an array of horizontal trellising wires. For some verities, such an MSHTS yields about 700 Kg/m² floor.

The system is provided useful for continuously yielding of plants' products when operated in a method comprising step or steps of providing a multi-story horizontal trellising system, characterized by one or more vertically erected stories; each story comprises an array of growing boxes located at the first end of an array of horizontal trellising wires; said trellising wires having a first end, located adjacent to said array of growing boxes and an opposite end, located far from said growing boxes; along said trellising wires there are provided two sections, a first section 73 begun at said first end of the said trellising wire; and a second section 74, terminated at said opposite end of the said trellising wire. Another set of steps is providing trellising wires to two or more sections, a first section begun at the first end of the trellising wire; and a last section, terminated at the opposite end of the trellising wire. For each of the stories, placing roots of leading plants P1(y_{1 . . . n}z_{1 . . . n}) within the array of growing boxes 1P1(y_{1 . . . n}z₁ . . . a)), and supporting its leaves by the trellising wires; cultivating the leading P1(y_{1 . . . n}z_{1 . . . n}) plants for a period of time, along the first section of the trellising wires. After a period of time, and for each of the stories, advancing leaves of the leading plants P1(y_{1 . . . n}z_{1 . . . n}) from the first section to the second section; trimming and pruning canopy of the leading plants P1(y_{1 . . . n}z_{1 . . . n}) along the first section; placing roots of first chasing plants P2(y_{1 . . . n}z_{1 . . . n}) within a second array of growing boxes 1P2(y_{1 . . . n}z_{1 . . . n}), located behind the first array of growing boxes 1P1(y_{1 . . . n}z_{1 . . . n}); supporting leaves of the first chasing plants P2(y_{1 . . . n}z_{1 . . . n}) at the beginning of the first section, now free of canopy of the leading plants P1(y_{1 . . . n}z_{1 . . . n}); and allowing the first chasing plants P2(y_{1 . . . n}z_{1 . . . n}) to yield for a given time in the first section; and after the period of time, removing both leaves of the leading plants P1(y_{1 . . . n}z_{1 . . . n}) and their growing boxes 1P1(y_{1 . . . n}z_{1 . . . n}); advancing the growing boxes of the first chasing plants forwards, as growing boxes of leading plants are now removed; placing roots of second chasing plants P3(y_{1 . . . n}z_{1 . . . n}) within a second array of growing boxes 1P2(y_{1 . . . n}z_{1 . . . n}), located behind the first array of growing boxes, now accommodating the first chasing plants P2(y_{1 . . . n}z_{1 . . . n}); allowing the first chasing plants P2(y_{1 . . . n}z_{1 . . . n}) to advance along the trellis wires, and to yield at the second section; and trellising canopy of the second chasing plants P3(y_{1 . . . n}z_{1 . . . n}) on the trellising wires at the beginning of the first section, now free of canopy and fruits of the first chasing plants P2(y_{1 . . . n}z_{1 . . . n}).

It is another object of the invention to disclose the system as defined above, wherein its operating method comprises step(s) of providing the MSHTS with a member of a group consisting of light emitter, light detector, light-activation processor, CO₂ detector, growing gutter, blower, air conditioning, ventilating duct, NTP decontaminating system, water irrigator, trellising wires tensioning mechanism, stem/leaves tensioning mechanism, additives applicator, and any combination thereof. It is another object of the invention to disclose the system as defined above, wherein its operating method comprises step(s) of providing the growing box comprises a member of a group consisting of rockwool/substrate cube; a plastic cover; apertures; L-shaped supporting member backing the about 90 bend in stem. It is another object of the invention to disclose the method as defined above, wherein its operating method comprises step(s) of emitting light along the trellising wires in a rate of leaves advancing. It is another object of the invention to disclose the system as defined above, wherein its operating method further comprises step(s) of vibrating the trellising wire, hence improving plant's pollination, technology applied for e.g., tomatoes and peppers.

### BRIEF DESCRIPTION OF THE FIGURES

The present invention will become more fully understood from the detailed description and the accompanying drawings, wherein

FIGS. 1a-c, each of which is illustrating in a non-limiting and an out-of-scale manners a set of schemes of a portion of an MSHTS, according to an embodiment of the invention;

FIGS. 2a and 2b, each of which is schematically illustrating a growing box 20 according to an embodiment of the invention;

FIGS. 3-6, schematically visualizing various MSHTS' operating method for continuously yielding plants' products according to an embodiment of the invention; and

FIGS. 7a-c, illustrating in a non-limiting manner a set of schemes of the “Leaders & Chasers” operating method, according to an embodiment of the invention.

### DETAILED DESCRIPTION OF THE PREFERRED EMBODIMENTS

The present invention will now be described more fully hereinafter with reference to the accompanying drawings, in which a preferred embodiment of the invention is shown. This invention may, however, be embodied in many different forms and should not be construed as limited to the embodiments set forth herein; rather, this embodiment is provided so that this disclosure will be thorough and complete and will fully convey the scope of the invention to those skilled in the art.

The phrase “controlled temperature environment” as used herein refers to an environment created by enclosure in which a desired temperature is maintained by any method known in the art.

The term “crop” (also denoted as “plant”) generally refers herein to any plant grown to be harvested, post-harvested or used for any economic purpose, including agriculture crops, aquaculture crops, horticulture crops, floriculture crops, and industrial crops. Crops currently use or usable with trellising agrotechnology are an example. Non-limiting examples of crops include crops intended for human or animal consumption (e.g., human food and livestock fodder), for use as clothing (e.g., fiber crops), for use as biofuel (e.g., energy crops, algae fuel), for use in medicine, and for use as decorative, ornamental, or recreational plants. Non-limiting examples of crops intended for human or animal consumption include stem plans, some are referred in a non-limiting manner in the table below, legumes (e.g., beans, peas, lentils, soybeans), forage crops, fruits and vegetables, tree nuts, and oil, fat and wax crops (e.g., oilseed crops such as canola, sunflower, coconut, palm, rapeseed, peanuts), herbs and medicinal plants such as vanilla pods, lavender, Cannabaceae plants, including cannabis plants and hop plants.

TABLE 1
Examples of some stem vegetables and plants' product thereof

| | | | |
|---|---|---|---|
| | | | COLLECTIVE NAME |
| | | | FOR MEMBERS OF |
| | SCIENTIFIC | | THE FAMILY, OTHER |
| CROP NAME | NAME | FAMILY | INFO |

Examples of stem vegetables with edible aboveground stems:

| | | | |
|---|---|---|---|
| Asparagus | Asparagus | Asparagaceae | Asparagus family, but |
| | officinalis | | formerly under Liliaceae |
| | | | (Merrill 1912); the edible |
| | | | part is the young shoot |
| | | | commonly called “spear,” |
| | | | best consumed when the |
| | | | tip is still tightly closed. |
| Bamboos | various species | Poaceae/Gramineae | Grass family; the edible |
| | | | part is the young, newly |
| | | | emerged shoot. |
| Cucumber | various species | Cucurbitaceae, also | Cucurbita - squash, |
| | | called cucurbits or the | pumpkin, zucchini, some |
| | | gourd family | gourds; Lagenaria - |
| | | | calabash, and others that |
| | | | are inedible; Citrullus - |
| | | | watermelon (C. lanatus, |
| | | | C. colocynthis) and others |
| | | | Cucumis - cucumber (C. |
| | | | sativus), various melons |
| | | | and vines; Momordica - |
| | | | bitter melon; Luffa |
| Kohlrabi | Brassica | Brassicaccae/Cruciferae | Mustard family, also |
| | oleracea var. | | called Cole Crops and |
| | gongylodes | | Crucifers; the main |
| | | | consumable plant part is |
| | | | the basal stem which |
| | | | forms a spherical |
| | | | structure. |
| Potato vine, | Ipomoea | Convolvulaceae | Morning Glory/Bindweed |
| kangkong | aquatica | | family; both stems and |
| | | | leaves are eaten cooked or |
| | | | blanched, |
| Tomato and | Solanum | Solanaceae | Solanaceae: eggplant (S. |
| others | lycopersicum | | melongena); Capsicum: |
| | | | chili peppers and bell |
| | | | peppers; Physalis: |
| | | | tomatillo (Physalis |
| | | | philadelphica), Physalis |
| | | | peruviana (Cape |
| | | | gooseberry) and Physalis |
| | | | alkekengi (Chinese |
| | | | lantern); Lycium: |
| | | | boxthorns and the goji |
| | | | berry, Lycium barbarum; |
| | | | Nicotiana: tobacco etc. |

Examples of stem vegetables with edible modified underground stem denoted herein
as bulb:

| | | | |
|---|---|---|---|
| Chive | Allium | Amaryllidaceae | Amaryllis family; |
| | schoenoprasum | | formerly under Liliaceae |
| | | | (Lily family, Merrill 1912) |
| | | | but Simpson (2010) |
| | | | preferred it under |
| | | | Alliaceae (Onion family or |
| | | | alliaceous crops); |
| | | | Alliaceae has been placed |
| | | | within an expanded |
| | | | Amaryllidaceae by the |
| | | | Angiosperm Phylogeny |
| | | | Group III (APG III, 2009). |
| Garlic | Allium sativum | Amaryllidaceae | Amaryllis family |
| | Allium porrum | Amaryllidaceae | Amaryllis family |
| Onion | Allium cepa | Amaryllidaceae | Amaryllis family |
| Shallot | Allium cepa, | Amaryllidaceae | Amaryllis family |
| | Aggregatum | | |
| | group | | |

Examples of stem vegetables with edible modified underground stem denoted herein
as tuber

| | | | |
|---|---|---|---|
| Jerusalem | Helianthus | Asteraceae/Compositae | Sunflower or Aster family |
| artichoke | tuberosus | | |
| Potato | Solanum | Solanaceae | Aka: Nightshade family |
| | tuberosum | | |
| Yam, ube, | Dioscorea | Dioscoreaceae | Yam family |
| Asiatic yam, | alata | | |
| tugui, apali, tamis | | | |

Examples of stem vegetables with edible modified underground stem denoted herein
as corm:

| | | | |
|---|---|---|---|
| Taro, gabi | Colocasia | Araceae | Arum family; some |
| | esculenta | | varieties are grown for |
| | | | their edible leaves and |
| | | | petioles and modified |
| | | | lateral stems (stolons) |
| Yautia, tannia, | Xanthosoma | Araceae | Arum family |
| bisol, karlang, | sagittifolium | | |
| palauan | | | |

As used herein, the term “about” refers to an amount that is near the stated amount by 10%, 5%, or 1%, including increments therein.

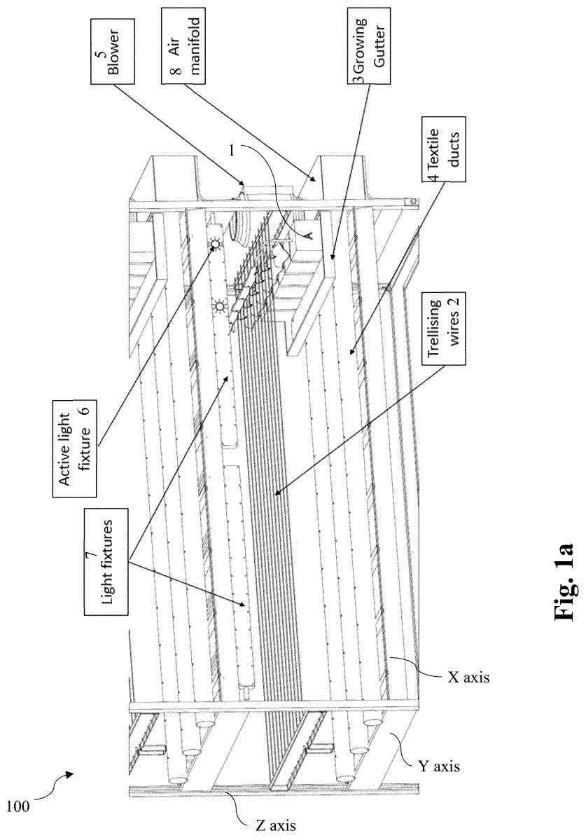

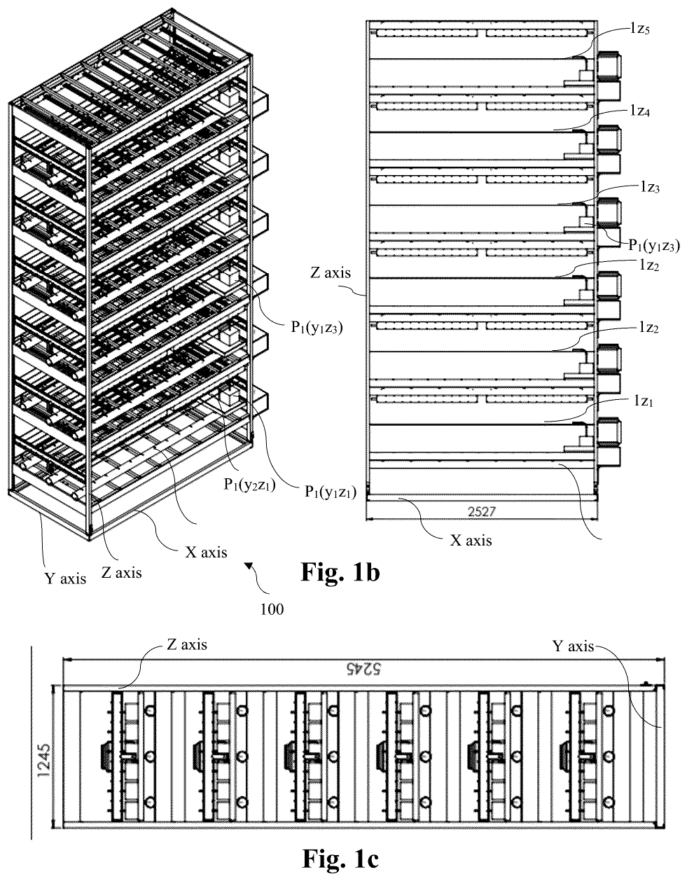

It is according to an embodiment of the invention wherein the crops are grown in a multi-story horizontal trellising system (MSHTS) and construction thereof see FIGS. 1a-5b. MSHTS is characterized by length (X axis), width (Y axis) and height (Z axis). The terms “story”. “level” and “floor” are interchangeably used herein below to define sections along the Z axis of MSHTS and will be marked as integers: Z₁, Z₂ . . . Zₙ. It is well within the scope of the invention wherein the horizontal trellising system is (at least temporarily) having only one floor, namely a “single-story horizontal trellising system”, where Z=1. It is also within the scope of the invention wherein a multistory horizontal trellising system is (at least temporarily-) is configured for growing a single plant at each floor, where Y=1. As those arrangements are privet cases of an yₙzₙ MSHTS, and figures discussed below are to be interpreted accordingly.

As for the nomenclature used along the figures, P₁(y₁z₃) defines the first (leading-) plant, located in the first growing box at the third level (story, floor-). 10P₂(y₄z₅), 11P₂(y₄z₅) and 12P₂(y₄z₅) denote a stem portion, leaves and fruits of a chasing plant 2, namely the one its roots are located within growing box number 4, at the fourth story, respectively.

Reference is now made to FIGS. 1a-c, each of which is illustrating in a non-limiting and an out-of-scale manners a set of schemes of a portion of an MSHTS 100, utilizable along the first stage of a “Leaders & Chasers” method which will be defined below, according to one embodiment of the invention. FIG. 1a schematically depicts length, width and height of the construction (x, y, z). A plurality of growing boxes (1) on a growing gutter (3) is located at the lower floor, set in parallel to the width. An array of trellising wires (2) is provided at the higher portion of the first floor in parallel to the long axis. Textile ducts (4) are located in this example at the lower portion of the first floor, positioned parallel to the long axis. Blower (5) is located here adjacent to the growing boxes. A set of active light fixtures and light fixtures (6, 7) located in this example in the topmost portion of the first floor. Possible dimensions are provided.

In each of the growing levels, an array of essentially horizontal trellising wires (2) is provided in parallel to the main longitudinal axis X. Trellising wires tensioning mechanism and stem/leaves a tensioning mechanism are an option.

In at least one story, or otherwise, in more than one story (Z₁, Z₂ . . . Zₙ), or otherwise, in each story, crops are planted either in situ or pre-planted in a remote location on a growing level inside either commercially available or a tailor-made pot, growing box, or a dedicated container, configured by means of size and shape to fit plant growing needs (hereinafter a “growing box”). Growing boxes are arranged in parallel to the width main axis Y:Y. In one set of embodiments, a number of growing boxes per story is ranging from about 2 growing boxes to about 20 stories (Y₂Zₙ-Y₂₀Zₙ), e.g., about 4 boxes to about 10 growing boxes (Y₄Zₙ-Y₁₀Zₙ), etc. It is possible that a number of growing boxes Y_{y′} in one story Zₙᵢ is different from the number of growing boxes Y_{y″} in another story Zⱼ, namely (Y_{y′}Zₙᵢ≠Y_{y″}Zₙⱼ); x, y, z, n, i, and j are integers equal or greater than 1. The growing box is e.g., an enveloping continuous sheet of a material, or alternatively, at least partially non-continuous member (e.g., porosive, multilayered, spiral wounded-) material made of polymer(s), cardboard, metallic materials, glass etc. It may have a single main volume or else wise, it is a multicompartment vessel or an assemble interconnected box-like jars. The growing boxes are erected perpendicular to the (essentially horizontal-) growing direction. An example of such a growing box is a cube of rock wool, placed in a dedicated gutter-like carrier.

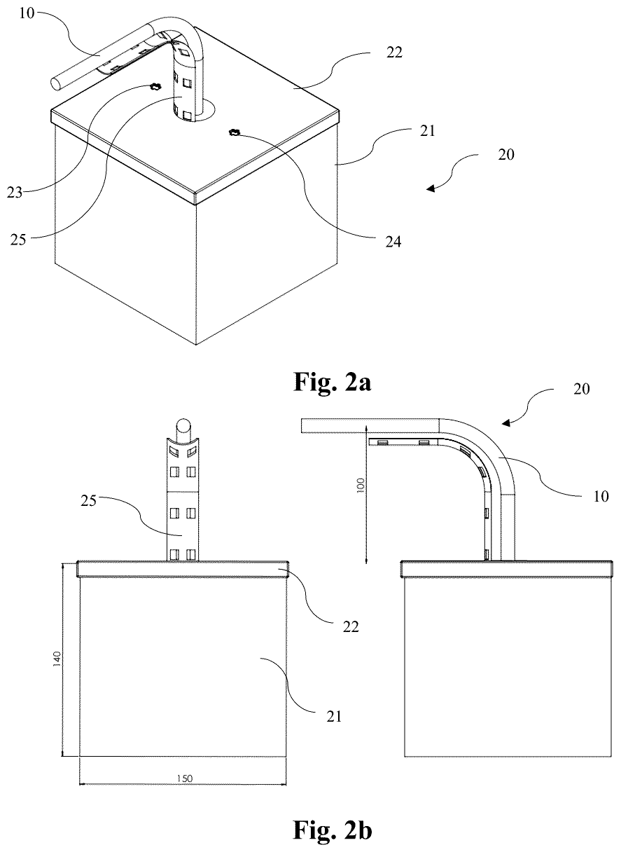

Reference is now made to FIGS. 2a and 2b, each of which is schematically illustrating a growing box 20 according to one embodiment of the invention. It comprises a Rockwool/substrate cube 21; a plastic cover 22; apertures 23,24, provided as, e.g., drippers inlet orifices; L-shaped supporting member 25 backing the 90°-bend in stem 10. Possible dimensions are provided.

Above each growing level there's a lighting level dedicated to the growing level adjunct to it, namely provide under, above and/or within the level. A traditional top-lighting requires hence a line of light emitting sources located above the growing level.

It is according to an embodiment of the invention wherein the system comprises a single (Z=1) story. It is according to an embodiment of the invention wherein in total, the structure of the racks builds of 2 to about 20 stories (Z<21), e.g., about 4 to about 10 stories (Z<1), e.g., about 6 stories (Z˜6). Each story consists of growth and trellising level and above it a lighting level.

It is according to an embodiment of the invention wherein at a heterogenous growing system is provided useful, namely a single MSHTS for growing more than one verity of. Hence, for example, cucumbers are grown in the first story, melons in the second story, and tomatoes in the third and fourth stories (Cucumber [Y₁₋₅Z₁], Melon [Y₁₋₃Z₂], Tomato [Y₁₋₆Z₃₋₄]). Additionally, or alternatively, according to another embodiment of the invention, a heterogenous growing system is provided useful. Here, in a specific story (Z₁) in an MSHTS, there are growing of more than one verity. Hence, for example, pumpkins are grown in the first and second growing boxes, and watermelons are grown in the third to sixth growing boxes (Pumpkin [Y₁₋₂ Zᵢ], Watermelon [Y₃₋₆Zᵢ]). A growing facility may comprise either or both homogeneous or heterogeneous MSHTS.

It is according to an embodiment of the invention wherein between the racks there are locatable service aisles.

An example is an MSHTS of about 0.5 to about 10 meters long, or alternatively, 1 to about 5 meters long, or alternatively about 2.4 meters long. Width ranges from 0.3 to about 5 meters; or alternatively from 0.5 to about 2.5 or alternatively about 1 meter. Height ranges from 0.5 to about 30, or alternatively from 2 to about 12 meters, or alternatively about 5 meters.

MSHTS may consist of horizontal gutters across a shelf. Each gutter contains from 2 to about 12 plants, or alternatively, about 6 plants. Each rack consists of 2 to about 12 shelves, e.g., 6 shelves one set above the other.

It is according to an embodiment of the invention wherein a method of MSHTS crops growing is disclosed. Along an initial stage of the growing process, a single or a few specific varieties are sown, planted, grafted, or otherwise provided within a growing media of the growing boxes; e.g., cucumbers are sown into a dedicated soilless plug.

Optionally, this first stage is performed outside a growing room. Typically, a process of nursery and young plants production includes a vegetative stage, preferably done in high-care rooms in the facility itself, in order to optimize the utilization of the growing area and to obtain a specific climate condition for each stage. Significant savings of expensive space is achieved by carrying out this vegetative stage in high-density of plants per square meter, on a dedicated racks system. In a subsequent step, provide after a predefined period of time, e.g., about a month, seedlings are planted in the afore the growing boxes.

Operation-wise wise, this system provides easy access for picking and leaves trimming. From a standing point at the aisle between two racks, an operator can reach to some six rows (three from each side of the aisle) and six stories up, whereas commercially available vertical trellising allows access to two rows only.

Automation-wise wise, because of the clear separation between leaves and fruits, the hereto-defined MSHTS is ideal for mechanized tasks (autonomously or semi-automatic) such as robotic picking (harvesting) and pruning of leaves during growth.

Auxin is a plant hormone that promotes cell growth and plants elongation. In the elongation process, Auxin alters the plant's wall plasticity hence promotes plant to vertical grow, whilst suppressing formation of new buds, thereby provides high density clusters, and increased yields. Hence, the horizontal-trellising based technology of the present invention gap between clusters ranges from to about 12 to about 15 cm, whereas in commercially available vertical trellising, a common gap between clusters traditionally ranges from 25 to 30 cm.

Profitability of traditional vertical trellis is relatively limited as plants effectively yield their fruits only in the advancing top portion and leave behind a gap of growing but not yielding stem. The hereto disclosed MSHTS uniquely utilizes optimized stems length for specific verities of plants (e.g., tomatoes and cucumbers, about 220 cm (differs between strains and crops)) while the yielding stem section ranges from approximately half of that (e.g., from about 80 to about 100 cm).

In one embodiment of the invention, electromagnetic radiation is transmitted by means of one or more sources. In vertical trellising systems, light projected from the ceiling downwardly hardly reaches the lower portions of the plants. In MSHTS however, leaves at each growing portion along the horizontal stem are subject to effective illumination, which optimized radiation of non-obscured light toward the leaves.

Plant varieties require specific light illumination patterns (spectrum, time-resolved intensity etc.). MSHTS's dynamic lighting mechanism comprises a sensor-based monitor adapted to light selected portions along the trellising, hence, to ensure energy savings, optimal heat production, plant growth, fruit (or other plant's product) production, maximal yielding rate and profitability. MSHTS's dynamic lighting mechanism is location-sensitive so that unnecessary lighting fixtures do not consume electricity and don't emit heat that is required to be evacuated by air conditioning system (e.g., HVAC system) for a controlled temperature environment. In some of the MSHTS, light is radiated only above the canopy. In other of the MSHTS, light is radiated above, below, or within the canopy with dedicated parameters, such as spectrum, frequency and lighting time, designed for this type of lighting.

Outdoor cultivation of certain plants, tomatoes for example, flowers must be pollinated by an external source, such as bees. In an indoor environment, however, it's not possible to pollinate by such a natural means. MSHTS optimizes plants' pollination by interconnecting trellising wires with effective vibrators configured to operate in a predefined frequency, intensity, pulses profile, amplitude and timing so that the pollens are dispersed evenly and pollinate effectively. MSHTS further optimizes the location along the trellis and the timing of pruning of plants' leaves at each segment of the trellis

MSHTS provides an effective (I) vertical stem growth within and adjacent the growing box, and then (ii) horizontal stem growth along the substantially horizontal trellising wires. Stem-leading clip ensures that the kinked stem does not break. It is e.g., an arch-(elbow) like member designed so an external clip may keep the stem adjacent to the stem. In an embodiment of the invention, the stem-leading clip is an arch connected to a base that covers the surface of the substrate cube and thus prevents light from reaching the substrate, to prevent contamination, e.g., by (green-) fungi, molds, etc. Lower portion of each story may comprise a few apertures: e.g., one for the plant and two for water and fertilizers irrigation pegs.

Plant requires optimal conditions of temperature and humidity, where an excess of humidity develops leaf diseases. For this purpose, and according to an embodiment of the invention, MSHTS provides an array of fabric ventilation ducts, installable near the plants to condition their proximate environment with controlled humidity and temperature.

According to yet another embodiment of the invention, MSHTS comprises a controlled supply and evacuation system for additives in either or both gas phase and liquid phase. The term “additive” refers in a non-limiting manner in this connection to biocides and preservatives (e.g., metal salts, a quaternary amine, bromomethane, ozone), plants hormones (e.g., ethylene and derivatives thereof, 1-methylcyclopropene), plants breeding agents and genetic materials, enzymes and coenzymes, plant extracts, microorganisms such as probiotics, germination agents, fertilizes, acidulants and buffers, carbon dioxide, anti-caking agents, nitrogen gas, antifoaming agents, antioxidants, bulking agents, emulsifiers, flavor enhancers, perfuming agents, fruit and seed-coating agents, fertilizers, mineral salts, calcium carbonate containing dust, stabilizers, starches, thickeners, UV stabilizers, blockers or enhancers, vitamins and minerals and any combination, derivatives and mixtures thereof.

According to yet another embodiment of the invention, MSHTS comprises a controlled CO₂ supply and evacuation system for both (1) maximizing plants' photosynthesis and (II) protecting human safety. The controlled CO₂ supply systems may comprise an array of fabric-made ducts.

According to yet another embodiment of the invention, MSHTS comprises non thermal plasma emitting (NTP) system. NTP is provided useful for electrically energizing and/or ionizing matter in a gaseous state, for decontaminating dried crops of its pathogens is hereto disclosed. NTP was found extremely effective in the decontamination of Staphylococcus aureus, Pseudomonas aeruginosa, Escherichia coli and Candida albicans, and others, such as Aspergillus brasiliensis, Salmonella, Legionella, COVID-19, molds etc. Some relevant data is derived from currently available link: https://www.vsdental.it/uploads/attachment/attachment/433/DOSSIER_scientifico%20JONX_R.03.pdf. An NTP was found effective to kill molds in a few minutes by ionizing the air, without requiring to add any additional chemicals. It is acknowledged that the number of NTP units (or their output) is proportional to the room size, Unlike other anti-molds treatments such as UV, in which molds will only be affected if they pass in proximity to the UV bulb, the hereto presented NTP system blows ionized air into the room, creates an atmosphere that neutralizes existing molds and prevents the development of new ones. Commercially available NTP and NTP-like means, are commercially available, including, e.g., DUCTT™ 70MIC4C product, by Jonix S.p.A. B Corporation (Italy) and Sterionizer™ D6 by FILT AIR Ltd (Israel).

NTP decontaminated plants' pathogens such as bacteria, viruses and molds dispersed in the air and pose a great danger to the quality and quantity of crops. NTP system consists of one or more independent NTP units installed within or in connection with HVAC ducts, thus ensuring optimal distribution throughout the room. An NTP unit may comprise a high voltage transformer connected to unique patented electrodes that produce electrical energy that ionized the air. Ionized air is distributed throughout the room and destroys the cell shell of the pathogens and thus they are neutralized.

An MSHTS-enabled “chasing plant” (also denoted as “Leaders & Chasers”) method technique is hence utilizable to fill a non-yielding gap along the stem of a first plant (Pₙ) with additional yielding stem portion of a subsequently following plant (“chasing plant”, Pₙ₊₁) that yields, along the horizontal trellis where the first plant no longer yields. This provides, along each trellis, a continuous yielding section comprising both P₂ and P₁ stem portions. This non-stopped continuity is enabled by timely planting chasing plant P₂: When P₁ leading plant ends its yielding period, it is removed, and replaced by yet a new chaser P₃, that now chases P₂, the first chaser, and so on and so forth.

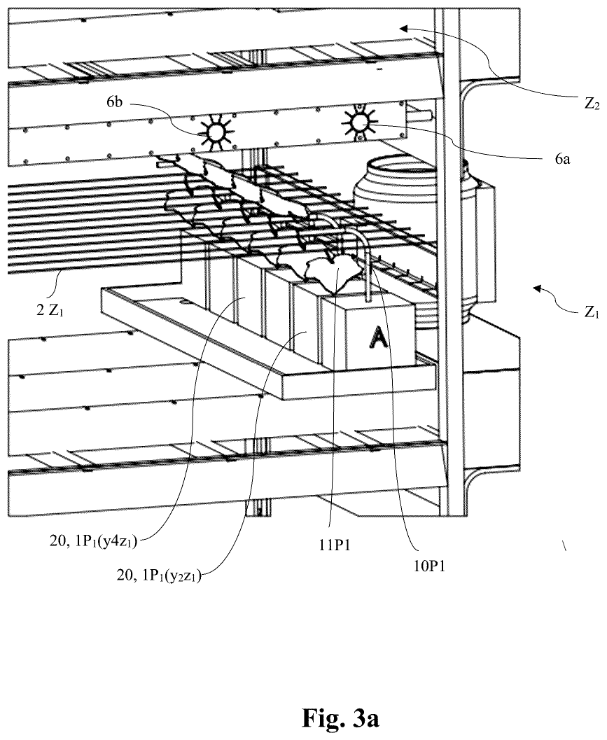

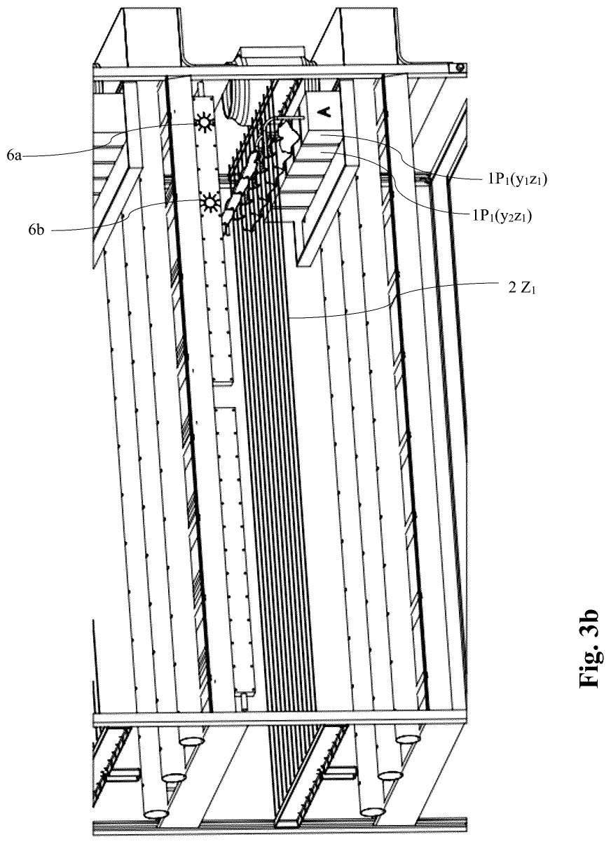

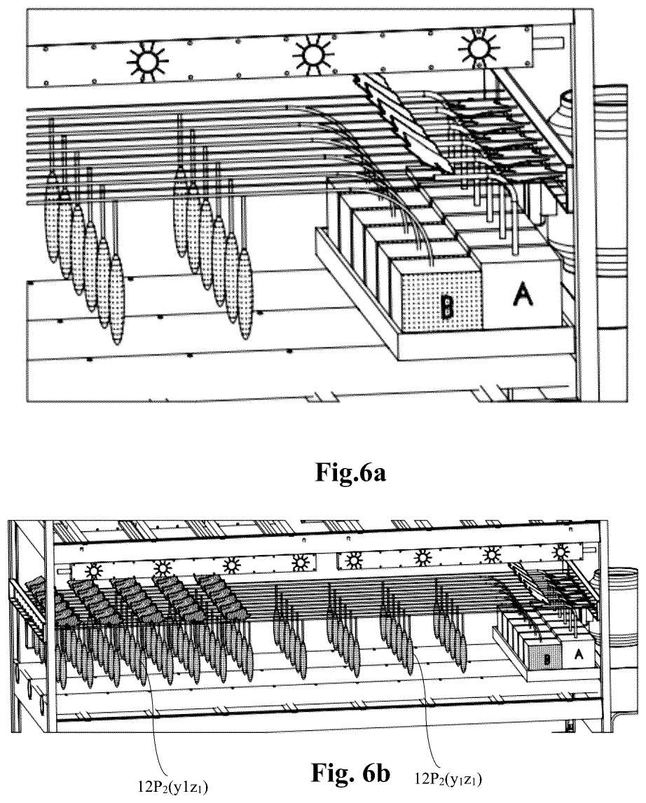

Reference is made to FIGS. 3-6, schematically visualizing various steps in a method for continuously yielding plants' products. The method comprises steps as follows: providing a MSHTS with one or more vertically erected stories. Each story comprises an array of growing boxes located at a first end of an array of horizontal trellising wires (2). The trellising wires having a first end, located adjacent to the array of growing boxes (1), and an opposite end, located far from the growing boxes. Along the trellising wires, there are provided two schematical sections, a first section 73 which begins at the first end of the trellising wire, near the growing boxes. A second section 74 starts immediately after the first section ends, and terminated at the opposite end of the trellising wire. For each of the MSHTS' stories, the required steps of (i) placing roots of leading plants P₁(y_{1 . . . n}z_{1 . . . n}) within an array of growing boxes P1(y_{1 . . . n}z_{1 . . . n}); and (ii) supporting its leaves or canopy thereof by the trellising wires. Then, the leading plants (P(y_{1 . . . n}z_{1 . . . n}) are cultivated for a period of time, along the first section of the trellising wires 73. Cultivation refers here to various agrotechniques, including e.g., pruning, trimming, irrigating, fertilizing, etc. After that period of time, and for each of the stories: advancing leaves (namely, plants' canopy, stem and fruits, when relevant) of leading plants P1(y_{1 . . . n}z_{1 . . . n}) from first section 73 to second section 74. At the same time, the canopy of leading plants P1(y_{1 . . . n}z_{1 . . . n}) is cultivated along the first section 73. Subsequently, and it is required to place roots of the first chasing plants P2(y_{1 . . . n}z_{1 . . . n}) within the second array of growing boxes 1P2(y_{1 . . . n}z_{1 . . . n}), located behind the first array of growing boxes 1P1(y_{1 . . . n}z_{1 . . . n}). Here again, leaves (or canopy thereof) of the first chasing plants P2(y_{1 . . . n}z_{1 . . . n}) is supported from the beginning of the first section 73, now free of the canopy of the leading plants P1(y_{1 . . . n}z_{1 . . . n}). The first chasing plants (P2(y_{1 . . . n}z_{1 . . . n}) are allowed to yield for a given period of time along the first section 73. After another period of time, both canopies of the leading plants P1(y_{1 . . . n}z_{1 . . . n}) and their growing boxes 1P1(y_{1 . . . n}z_{1 . . . n}) are removed. Then, growing boxes of the first chasing plants are advanced forwards, as growing boxes of leading plants are now removed. As described before, roots of second chasing plants P₃(y_{1 . . . n}z_{1 . . . n}) are now placed within a second array of growing boxes 1P2(y_{1 . . . n}z_{1 . . . n}), located behind the first array of growing boxes, now accommodating the first chasing plants P2(y_{1 . . . n}z_{1 . . . n}). The first chasing plants P2(y_{1 . . . n}z_{1 . . . n}) is allowed to advance along the trellis wires, and to yield at the second section 74. At that time, the canopy of the second chasing plants P3(y_{1 . . . n}z_{1 . . . n}) is being supported on the trellising wires at the beginning of the first section 73, now free of canopy and fruits of the first chasing plants P2(y_{1 . . . n}z_{1 . . . n}).

It is in the scope of the invention wherein an objective of the nursery stages in the method using leading and chasing plants is to grow P₂'s seedlings close to the stage of P₁'s ripening, namely, a time when a flower becomes a fruit. For this purpose, a novel clip is provided useful for allowing seedlings to grow horizontally to this right stage and being transferred with no harm from the nursery to the commercial growing facility.

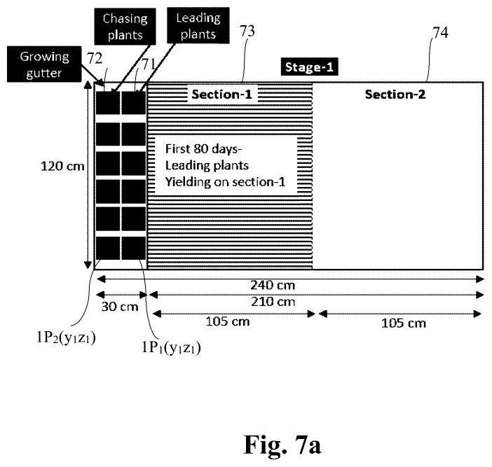

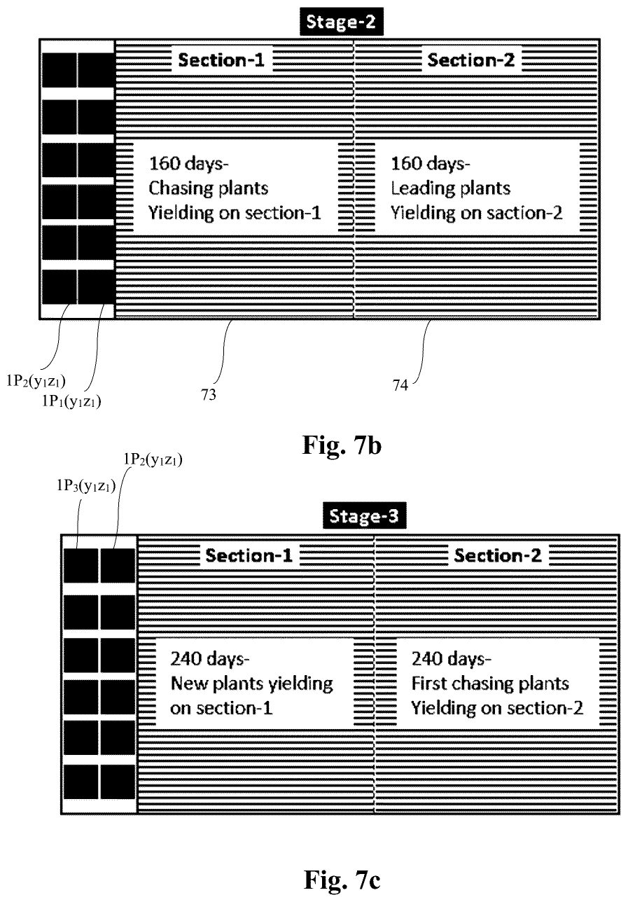

Reference is now made to FIGS. 7a-c, illustrating in a non-limiting manner a set of schemes of the “Leaders & Chasers” method, according to one embodiment of the invention. In a 1^{st} step, (FIG. 7a) leading plants are placed an array of growing boxes located (1P1(y_{1 . . . n}z_{1 . . . n}), n is any integer, equal or greater than 1) in a first section, close to the trellis wires. Now the leading plants yields for a given time (e.g., in several varieties of tomatoes, about 80 days) in the first section 73 along the trellis wires. Dimensions are listed in FIG. 1a as an example. After the aforesaid period of about 80 days, 2^{nd} step begins (FIG. 7b). Leading plants are advancing along the trellis wires and are yielding in second section 74. Chasing plants (P2(y_{1 . . . n}z_{1 . . . n})) yields along first section 73. In 3^{rd} step (FIG. 7c), original Leading plants (P1(y_{1 . . . n}z_{1 . . . n})) are removed, and new chasing plants (P3(y_{1 . . . n}z_{1 . . . n})) are provided to yield along the first section 73, whilst old chasing plants (P2(y_{1 . . . n}z_{1 . . . n})) yield on the second section 74, and so on and so forth. This cycle continues repeatedly, so there will always be yielding plants in the two sections.

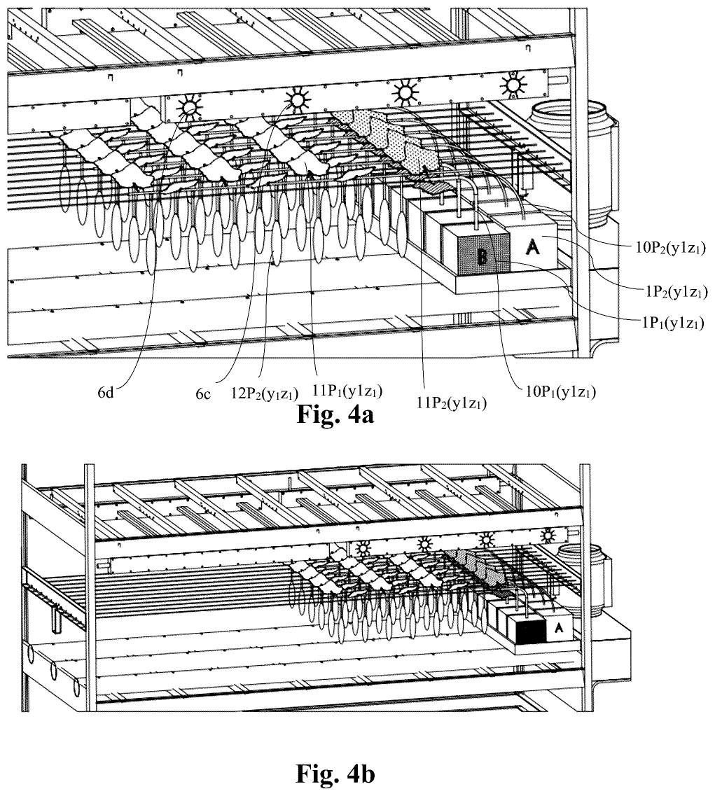

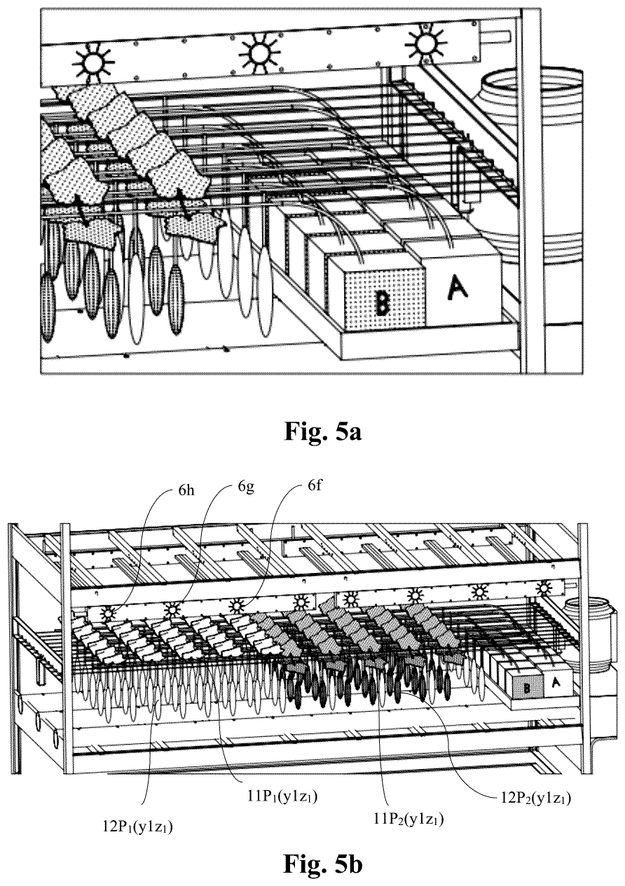

According to one embodiment of the invention, light advances along the advancing of plants' canopy along the trellis. Reference is now made to FIG. 3b, showing that only first light emitter 6a-b are used for lighting the first growing section 73, then lights 6c-d are used (FIG. 4a), and finally, when both leading and chasing plants are both trellised in sections 73 and 74 (FIG. 5a), all lights (6a-g) are used.

It is well in the scope of the invention wherein more than two generations of plants are used: namely one array of leading plants and one array of chasing plants. It is also in the scope of the invention wherein more than two sections (73, 74) are used. Hence, e.g., a leading army of plants may be followed by two chasing plants, in and MSHTS which comprises three sections etc.

An MSHTS as defined above, namely one which comprises six levels, where 1 m² per one level is multiplied by six to get the total yield of a 1 m² of floor. This MSHTS yields with some 800 kg/m² floor for Cucumber's strain A; 650 kg/m² floor for Cucumber's strain B; and some 700 kg/m² floor for Tomatoes strain A.

In the specification, there have been disclosed typical preferred embodiments of the disclosure and although specific terms are employed, they are used in a generic and descriptive sense only and not for purposes of limitation. Some typical embodiments of the disclosure have been described. Many more examples, modifications and variations of the disclosure are possible in light of the above teachings. For instance, although the disclosure and the claims indicate specific steps to perform the invention, the steps described are not limited to a particular sequence of performance and in some circumstances two or more of these steps could be undertaken simultaneously. It is therefore to be understood that within the scope of the appended claims the disclosure may be practiced otherwise than as specifically described, and the scope of the disclosure is set out in the claims.

1.-14. (canceled)

15. A multi-story horizontal trellising system (MSHTS) characterized by one or more vertically erected stories; each story comprises one or more arrays of growing boxes located at the first end of an array of horizontal trellising wires; said trellising wires having a first end, located adjacent to said one or more arrays of growing boxes and an opposite end, located far from said growing boxes; along said trellising wires there are provided two sections, a first section 73 begun at said first end of the said trellising wire; and a second section 74, terminated at said opposite end of the said trellising wire; wherein each said story is configured to accommodate of one or more leading plants Pₓ(y_{1 . . . n}z_{1 . . . n}) within array 1Pₓ(y_{1 . . . n}z_{1 . . . n}) of growing boxes, and is further characterized by said trellising wires being configured to support leaves of said leading plants; further wherein each said story is further configured to accommodate roots of one or more first chasing plants Pₓ₊₁(y_{1 . . . n}z_{1 . . . n}) within array 1Pₓ₊₁(y_{1 . . . n}z_{1 . . . n}) of growing boxes, said 1Pₓ₊₁(y_{1 . . . n}z_{1 . . . n}) array located behind said 1Pₓ₊₁(y_{1 . . . n}z_{1 . . . n}) array, and is further characterized by said trellising wires being configured to support leaves of said first chasing plants; wherein said array 1Pₓ(y_{1 . . . n}z_{1 . . . n}) is configured for initially cultivating said leading plants Pₓ(y_{1 . . . n}z_{1 . . . n}) along said first section 73 of said relisting wires; wherein said first section 73 is configured for initially supporting leaves of said leading plants Pₓ(y_{1 . . . n}z_{1 . . . n}) and for consecutively supporting leaves of said first chasing plants Pₓ₊₁(y_{1 . . . n}z_{1 . . . n}); further wherein said second section 74 is configured for supporting leaves of said leading plants Pₓ(y_{1 . . . n}z_{1 . . . n}) simultaneously with section 73 supporting said first chasing plants Pₓ₊₁(y_{1 . . . n}z_{1 . . . n}), and for consequentially supporting leaves of said first chasing plants Pₓ₊₁(y_{1 . . . n}z_{1 . . . n}); further wherein, said 1Pₓ (y_{1 . . . n}z_{1 . . . n}) array and said leading plants Pₓ(y_{1 . . . n}z_{1 . . . n}) are configured to be consequentially removed, thereby enabling said 1Pₓ₊₁(y_{1 . . . n}z_{1 . . . n}) array to be advanced forwards to previous position of said 1Pₓ (y_{1 . . . n}z_{1 . . . n}) array, to advance an 1Pₓ₊₂(y_{1 . . . n}z_{1 . . . n}) array to previous position of said 1Pₓ₊₁(y_{1 . . . n}z_{1 . . . n}) array, to advance a 1Pₓ(y_{1 . . . n}z_{1 . . . n}) array to previous position of a 1Pₙ₋₁(y_{1 . . . n}z_{1 . . . n}) array, and to add a new 1Pₓ(y_{1 . . . n}z_{1 . . . n}) array, thereby enabling succession of arrays while constantly utilizing both section 73 and section 74 without interrupting yield.

16. The MSHTS of claim 15, further comprising a member of a group consisting of a light emitter, light detector, light-activation processor, light fixture, active light fixture, textile ducts, CO₂ detector, growing gutter, gutter-like carrier, blower, air conditioning, ventilating ducts, NTP decontaminating systems, water irrigators, trellising wires tensioning mechanism, stem/leaves tensioning mechanism, additives applicator, and any combination thereof.

17. The MSHTS of claim 15, characterized by that the growing box comprises a member of a group consisting of Rockwool/substrate cube 21; a plastic cover 22; apertures 23,24; L-shaped supporting member 25 backing the 90°-bend in stem 10.

18. The MSHTS of claim 16, characterized by at least one of the following:
a. said array of growing boxes being located on said growing gutter on said one or more story, in parallel to width axis of said story;
b. said array of trellising wires being located at a higher portion of said story, in parallel to length axis of said story;
c. said textile ducts being located at a lower portion of said story, in parallel to length axis of said story;
d. said blower being adjacent to said growing boxes; and
e. a set of active light fixtures and light fixtures located in a topmost portion of said story.

19. The MSHTS of claim 16, characterized by said growing boxes being erected perpendicularly to growing direction of said plants.

20. The MSHTS of claim 19, wherein at least one of the following is held true:
a. said growing box is a cube of rock wool, placed in said gutter-like carrier;
b. number of stories Z is less than 21;
c. wherein number of stories Z is equal to 6;
d. each one of said stories comprises one or more plant varieties;
e. each one of said growing boxes comprises one or more plant varieties;
f. each of said at least one stories comprises a growth level, a trellising level, and above them a lightening level;
g. each said growing gutter comprises 2-12 plants.

21. The MSHTS of claim 15, wherein electromagnetic radiation is transmitted by means of one or more sources.

22. A multi-story horizontal trellising system (MSHTS) of claim 15, characterized by one or more vertically erected stories; each story comprises an array of growing boxes located at the first end of an array of horizontal trellising wires.

23. The MSHTS of claim 15, further comprising a member of a group consisting of a light emitter, light detector, light-activation processor, CO₂ detector, growing gutter, blower, air conditioning, ventilating ducts, NTP decontaminating systems, water irrigators, trellising wires tensioning mechanism, stem/leaves tensioning mechanism, additives applicator, and any combination thereof.

24. The MSHTS of claim 15, characterized by that the growing box comprises a member of a group consisting of Rockwool/substrate cube 21; a plastic cover 22; apertures 23,24; L-shaped supporting member 25 backing the 90°-bend in stem 10.

25. The MSHTS of claim 15, wherein its operation method comprises steps of
a. providing a multi-story horizontal trellising system, characterized by one or more vertically erected stories; each story comprises an array of growing boxes located at the first end of an array of horizontal trellising wires; said trellising wires having a first end, located adjacent to said array of growing boxes and an opposite end, located far from said growing boxes; along said trellising wires there are provided two sections, a first section 73 begun at said first end of the said trellising wire; and a second section 74, terminated at said opposite end of the said trellising wire;
b. for each of said stories, placing roots of leading plants P1(y_{1 . . . n}z_{1 . . . n}) within the said array of growing boxes 1P1(y_{1 . . . n}z_{1 . . . n})), and supporting its leaves by said trellising wires;
c. cultivating said leading P1(y_{1 . . . n}z_{1 . . . n}) plants for a period of time, along said the first section of said trellising wires 73;
d. after said period of time, and for each of said stories,
(i) advancing leaves of said leading plants P1(y_{1 . . . n}z_{1 . . . n}) from said first section 73 to said second section 74;
(ii) trimming and pruning canopy of said leading plants P1(y_{1 . . . n}z_{1 . . . n}) along said first section 73;
(iii) placing roots of first chasing plants P2(y_{1 . . . n}z_{1 . . . n}) within a second array of growing boxes 1P2(y_{1 . . . n}z_{1 . . . n}), located behind said first array of growing boxes 1P1(y_{1 . . . n}z_{1 . . . n});
(iv) supporting leaves of said first chasing plants P2(y_{1 . . . n}z_{1 . . . n}) at the beginning of said first section 73, now free of canopy of said leading plants P1(y_{1 . . . n}z_{1 . . . n}); and
(v) allowing said first chasing plants P2(y_{1 . . . n}z_{1 . . . n}) to yield for a given time in said first section 73; and
e. after said period of time,
(i) removing both leaves of said leading plants P1(y_{1 . . . n}z_{1 . . . n}) and their growing boxes 1P1(y_{1 . . . n}z_{1 . . . n});
(ii) advancing said growing boxes of said first chasing plants forwards, as growing boxes of leading plants are now removed;
(iii) placing roots of second chasing plants P3(y_{1 . . . n}z_{1 . . . n}) within the second array of growing boxes 1P2(y_{1 . . . n}z_{1 . . . n}), located behind the said first array of growing boxes, now accommodating said first chasing plants P2(y_{1 . . . n}z_{1 . . . n});
(iv) allowing said first chasing plants P2(y_{1 . . . n}z_{1 . . . n}) to advance along said trellis wires, and to yield at said second section 74; and
(v) trellising canopy of said second chasing plants P3(y_{1 . . . n}z_{1 . . . n}) on said trellising wires at the beginning of said first section 73, now free of canopy and fruits of said first chasing plants P2(y_{1 . . . n}z_{1 . . . n}).

26. The method defined in claim 25, further comprising step of providing said MSHTS with a member of a group consisting of light emitter, light detector, light-activation processor, CO₂ detector, growing gutter, blower, air conditioning, ventilating ducts, NTP decontaminating systems, water irrigators, trellising wires tensioning mechanism, stem/leaves tensioning mechanism, additives applicator, and any combination thereof, optionally, said operating method further comprising step of providing said growing box comprises a member of a group consisting of Rockwool/substrate cube 21; a plastic cover 22; apertures 23,24; L-shaped supporting member 25 backing the 90°-bend in stem 10; further optionally, said operating method further comprising step of emitting light along the trellising wires in a rate of leaves advancing.

27. The method defined in claim 25, further comprising step of providing said MSHTS with a member of a group consisting of light emitter, light detector, light-activation processor, CO₂ detector, growing gutter, blower, air conditioning, ventilating ducts, NTP decontaminating systems, water irrigators, trellising wires tensioning mechanism, stem/leaves tensioning mechanism, additives applicator, and any combination thereof.

28. The method defined in claim 25, further comprising at least one step as follows:
a. step of providing said growing box comprises a member of a group consisting of Rockwool/substrate cube 21; a plastic cover 22; apertures 23,24; L-shaped supporting member 25 backing the 90-bend in stem;
b. step of emitting light along the trellising wires in a rate of leaves advancing; and
c. step of vibrating the trellising wire, hence improving plant's pollination.
